(19) United States
(12) Patent Application Publication
(10) Pub. No.: US 2012/0106644 A1
(43) Pub. Date: May 3, 2012

(54) REFERENCE FRAME FOR VIDEO ENCODING AND DECODING

(75) Inventors: FELIX HENRY, Rennes (FR); CHRISTOPHE GISQUET, Rennes (FR)

(73) Assignee: CANON KABUSHIKI KAISHA, Tokyo (JP)

(21) Appl. No.: 13/283,386

(22) Filed: Oct. 27, 2011

(30) Foreign Application Priority Data
Oct. 29, 2010 (GB) 1018251.7

(51) Int. Cl. H04N 7/26

(52) U.S. Cl. 375/240.16; 375/E07.104; 375/E07.243

(57) ABSTRACT

A method for encoding is adapted to process a digital video signal composed of video frames into a bitstream. Each frame is divided into blocks and at least one block of a current frame is encoded by motion compensation using a block of a reference frame. The method comprises computing a difference frame between a current frame and a reference frame of said current frame, and selecting a subset of data representative of the difference frame computed. The subset of data selected is further encoded to obtain an encoded difference frame. Next, the encoded difference frame is decoded and the decoded difference frame is added to the reference frame to obtain an improved reference frame. Subsequently, the improved reference frame is used for motion compensation encoding of said current frame.

### FIELD OF THE INVENTION

The invention relates to a method and device for encoding a digital video signal and a method and device for decoding a compressed bitstream.

The invention belongs to the field of digital signal processing. A digital signal, such as for example a digital video signal, is generally captured by a capturing device, such as a digital camcorder, having a high quality sensor. Given the capacities of modern capture devices, an original digital signal is likely to have a very high resolution, and, consequently, a very high bitrate. Such a high resolution, high bitrate signal is too large for convenient transmission over a network and/or convenient storage.

### DESCRIPTION OF THE PRIOR-ART

In order to solve this problem, it is known in the prior art to compress an original digital video signal into a compressed bitstream.

In particular, several video compression formats are known. Most video compression formats, for example H.263, H.264, MPEG-1, MPEG-2, MPEG-4, SVC, referred to collectively as MPEG-type formats, use block-based discrete cosine transform (DCT) and motion compensation to remove spatial and temporal redundancies. They can be referred to as predictive video formats. Each frame or image of the video signal is divided into slices which are encoded and can be decoded independently. A slice is typically a rectangular portion of the frame, or more generally, a portion of an image. Further, each slice is divided into macroblocks (MBs), and each macroblock is further divided into blocks, typically blocks of 8×8 pixels. The encoded frames are of two types: predicted frames (either predicted from one reference frame called P-frames or predicted from two reference frames called B-frames) and non predicted frames (called Intra frames or I-frames).

To encode an Intra frame, the image is divided into blocks of pixels, a DCT is applied on each block, followed by quantization and the quantized DCT coefficients are encoded using an entropy encoder.

For predicted frames, motion estimation is applied to each block of the considered predicted frame with respect to one (for P-frames) or several (for B-frames) reference frames, and one or several reference blocks are selected. The reference frames are previously encoded and reconstructed frames. The difference block between the original block to encode and its reference block pointed to by the motion vector is calculated. The difference block is called a residual block or residual data. A DCT is then applied to each residual block, and then, quantization is applied to the transformed residual data, followed by an entropy encoding.

There is a need for improving the video compression by providing a better distortion-rate compromise for compressed bitstreams, either a better quality at a given bitrate or a lower bitrate for a given quality.

A possible way of improving a video compression algorithm is improving the predictive encoding, and in particular improving the reference frame or frames, aiming at ensuring that a reference block is close to the block to encode. Indeed, if the reference block is close to the block to encode, the coding cost of the residual is diminished.

In the article “Weighted prediction in the H.264/MPEG AVC video coding standard”, by Jill M. Boyce, presented in the IEEE Symposium on Circuits and Systems, Vancouver BC, pp. 789-792, it is proposed to apply an affine transform to a reference frame, the parameters of the affine transform being computed based on the difference between the frame to be encoded and the reference frame. Consequently, in global weighted prediction, an affine transform is applied to the reference frame to obtain a transformed reference frame which is closer to the frame to encode. In a local approach, the affine transform may be applied block by block, and the parameters may be computer per block, based upon the difference between the original block and the reference block provided by motion compensation. The residue is then calculated per block, as the difference between the transformed reference block and the original block to encode. The affine transform parameters are transmitted to a decoder in view of applying the same affine transform at the decoder.

This prior art brings an improvement of the reference frame, but such an improvement is limited since in some cases, the difference between a reference frame and an original frame to encode may not be well modeled via an affine transform. Further, an affine transform of a reference frame may compensate for differences that can be easily compensable via the classical motion compensation.

### SUMMARY OF THE INVENTION

It is desirable to address one or more of the prior art drawbacks. To that end, the invention relates to a method for encoding a digital video signal composed of video frames into a bitstream, each video frame being divided into blocks, wherein at least one block of a current frame is encoded by motion compensation using a block of a reference frame. The encoding method comprises the steps of:

computing a difference frame between a current frame and a reference frame of said current frame,

selecting a subset of data representative of the difference frame computed,

encoding said subset of data to obtain an encoded difference frame,

decoding said encoded difference frame and adding the decoded difference frame to said reference frame to obtain an improved reference frame and

using said improved reference frame for motion compensation encoding of said current frame.

Advantageously, the subset of data representative of the difference frame can be selected according an adaptive criterion, taking into account the specific characteristics of the digital video signal to encode. Further, the amount of data to represent the encoded frame difference can be finely tuned, for example in terms of rate-distortion optimization, so as to obtain a good reference frame improvement provided a given bitrate.

According to an embodiment, the method further comprises a step of including the encoded difference frame in the bitstream. Therefore, the encoded frame difference is sent to the decoder along with the encoded video data and can be easily retrieved by a decoder.

According to an embodiment, an item of information indicating the subset of data selected is encoded in the bitstream. In particular, this is compatible with an adaptive selection of the subset of data representative of the difference frame and allows better adaptation to the video signal characteristics.

According to an embodiment, the step of selecting a subset of data further comprises:

applying a transform to the difference frame computed to generate a plurality of transform coefficients, and

selecting a set of transform coefficients to form a subset of data representative of the difference frame.

The representation of video and image signals in a transform domain allows better capturing the space and frequency characteristics of the image signals, and enhances the compaction of representation of an image signal.

According to an embodiment, the step of selecting a set of transform coefficients comprises:

determining, among the plurality of transform coefficients, a first set of transform coefficients representative of motion information of said difference frame, and

selecting a set of transform coefficients from transform coefficients that do not belong to the first set of transform coefficients.

In this embodiment, the set of transform coefficients selected represent other details of the difference frame than motion details, since motion details are advantageously compensated using motion compensation. For example, illumination differences can be advantageously represented and taken into account in the improved reference frame.

According to a particular aspect of this embodiment, the plurality of transform coefficients are organized in a plurality of subbands of coefficients, a said first set of transform coefficients being selected as the subband of coefficients having the highest energy content.

Advantageously, the first set of coefficients representative of motion is easily selected, so the amount of calculations is low.

According to a particular aspect of this embodiment, each subband of coefficients has an associated resolution level, and the set of transform coefficients selected comprises coefficients belonging to subbands of coefficients of resolution level lower than the resolution level of the subband of coefficients forming the first set of transform coefficients.

This selection is advantageous since it provides coefficients representative of large scale details which are representative of illumination changes.

According to another embodiment, the step of selecting a set of transform coefficients comprises selecting adaptively a set of transform coefficients based upon a cost criterion. In particular, the encoding cost of the subset of data representative of the difference frame is controlled in this embodiment.

According to a particular aspect of this embodiment, the plurality of transform coefficients is organized in a plurality of subbands of coefficients, and the step of selecting adaptively a set of transform coefficients comprises, for each subband of coefficients taken in a predetermined order:

applying encoding and decoding of said subband of coefficients,

estimating an encoding cost of said subband of coefficients, and

selecting said subband of coefficients if said encoding cost is lower than a threshold.

According to a particular embodiment, the encoding cost is a rate-distortion cost computed using a parameter used to encode video data of said digital video.

According to an embodiment, the threshold is dependent, for each subband of coefficients, on the coefficients of said subband of coefficients. This allows better adapting to the characteristics of the motion of the difference frame.

According to an embodiment, the plurality of transform coefficients is organized in a plurality of subbands of coefficients, and a predetermined set of subbands of transform coefficients is selected. This embodiment has the advantage of being simple to implement.

According to an embodiment, the encoding method further comprises a step of encoding the set of transform coefficients selected to obtain the encoded difference frame.

In particular, the step of encoding the set of transform coefficients selected comprises quantizing the coefficients of the set of transform coefficients selected.

This is advantageous since the set of selected transform coefficients is compressed, so less data is necessary to represent it.

According to an embodiment, the encoding of the set of transform coefficients selected comprises selecting at least one encoding parameter so as to satisfy a rate and/or distortion criterion. In particular, the quantization step or steps can be selected according to a rate-distortion criterion.

According to a another aspect, the invention relates to a device for encoding a digital video signal composed of video frames into a bitstream, each video frame being divided into blocks, wherein at least one block of a current frame is encoded by motion compensation using a block of a reference frame, comprising:

means for computing a difference frame between a current frame and a reference frame of said current frame,

means for selecting a subset of data representative of the difference frame computed,

means for encoding said subset of data to obtain an encoded difference frame,

means for decoding said encoded difference frame and adding the decoded difference frame to said reference frame to obtain an improved reference frame and

means for using said improved reference frame for motion compensation encoding of said current frame.

According to a yet another aspect, the invention also relates to an information storage means that can be read by a computer or a microprocessor, this storage means being removable, and storing instructions of a computer program for the implementation of the method for encoding a digital video signal as briefly described above.

According to yet another aspect, the invention also relates to a computer program product that can be loaded into a programmable apparatus, comprising sequences of instructions for implementing a method for encoding a digital video signal as briefly described above, when the program is loaded into and executed by the programmable apparatus. Such a computer program may be transitory or non transitory. In an implementation, the computer program can be stored on a non-transitory computer-readable carrier medium.

The particular characteristics and advantages of the device for encoding a digital video signal, of the storage means and of the computer program product being similar to those of the digital video signal encoding method, they are not repeated here.

According to yet another aspect, the invention also relates to a method for decoding a bitstream comprising encoded frames representative of a digital video signal, each video frame being divided into blocks, wherein at least one block of a current frame is encoded by motion compensation using a block of a reference frame, comprising the following steps :

obtaining a reference frame for a current frame to decode,

obtaining an encoded difference frame representative of the difference between said reference frame and said current frame to decode,

decoding said encoded difference frame to obtain a decoded difference frame,

adding the decoded difference frame to said reference frame to obtain an improved reference frame and

using said improved reference frame for motion compensation decoding of said current frame to decode.

The method for decoding a bitstream has the advantage of using an improved reference frame to provide to a better decoded video frame, the improved reference frame being provided by an encoder and being adapted to the characteristics of the video signal.

According to yet another aspect, the invention also relates to a device for decoding a bitstream comprising encoded frames representative of a digital video signal, each video frame being divided into blocks, wherein at least one block of a current frame is encoded by motion compensation using a block of a reference frame, comprising:

means for obtaining a reference frame for a current frame to decode,

means for obtaining an encoded difference frame representative of the difference between said reference frame and said current frame to decode,

means for decoding said encoded difference frame to obtain a decoded difference frame,

means for adding the decoded difference frame to said reference frame to obtain an improved reference frame and

means for using said improved reference frame for motion compensation decoding of said current frame to decode.

According to a yet another aspect, the invention also relates to an information storage means that can be read by a computer or a microprocessor, this storage means being removable, and storing instructions of a computer program for the implementation of the method for decoding a bitstream as briefly described above.

According to yet another aspect, the invention also relates to a computer program product that can be loaded into a programmable apparatus, comprising sequences of instructions for implementing a method for decoding a bitstream as briefly described above, when the program is loaded into and executed by the programmable apparatus. Such a computer program may be transitory or non transitory. In an implementation, the computer program can be stored on a non-transitory computer-readable carrier medium.

The particular characteristics and advantages of the device for decoding a bitstream, of the storage means and of the computer program product being similar to those of the decoding method, they are not repeated here.

According to yet another aspect, the invention relates to a bitstream comprising encoded frames representative of a digital video signal, each video frame being divided into blocks, wherein at least one block of a current frame is encoded by motion compensation using a block of a reference frame. The bitstream comprises data representative of an encoded difference frame obtained by:

computing a difference frame between a current frame and a reference frame of said current frame,

selecting a subset of data representative of the difference frame computed,

encoding said subset of data to obtain an encoded difference frame.

Advantageously, such a bitstream carries an encoded difference frame which can be used by a decoder to reconstruct an improved reference frame to be used in motion compensation and to obtain a better quality of video frame reconstruction.

### BRIEF DESCRIPTION OF THE DRAWINGS

Other features and advantages will appear in the following description, which is given solely by way of non-limiting example and made with reference to the accompanying drawings, in which:

FIG. 1 is a diagram of a processing device adapted to implement an embodiment of the present invention;

FIG. 2 illustrates a system for processing a digital video signal in which the invention is implemented;

FIG. 3 is a block diagram illustrating a structure of a video encoder according to an embodiment of the invention;

FIG. 4 illustrates the main steps of an encoding method according to an embodiment of the invention;

FIG. 5 represents schematically an example of original image;

FIG. 6 illustrates schematically an example of subband decomposition of the image of FIG. 5;

FIG. 7 illustrates a first embodiment of selecting a set of transform coefficients;

FIG. 8 illustrates a second embodiment of selecting a set of transform coefficients,

and

FIG. 9 illustrates the main steps of a method for decoding a video bitstream using an improved reference frame according to an embodiment of the invention.

### DETAILED DESCRIPTION OF THE EMBODIMENTS

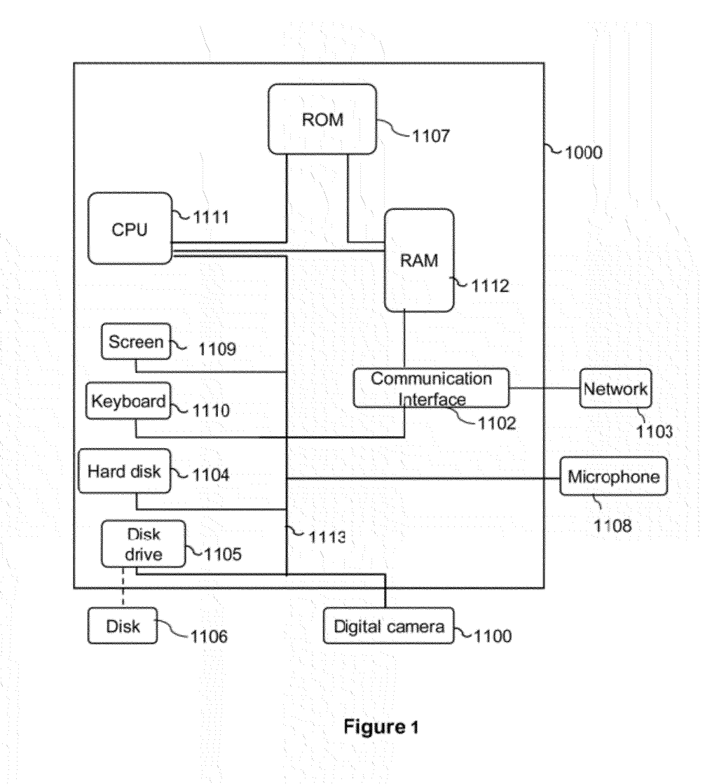

FIG. 1 illustrates a diagram of a processing device 1000 adapted to implement one embodiment of the present invention. The apparatus 1000 is for example a micro-computer, a workstation or a light portable device.

The apparatus 1000 comprises a communication bus 1113 to which there are preferably connected:

a central processing unit 1111, such as a microprocessor, denoted CPU;

a read only memory 1107 able to contain computer programs for implementing the invention, denoted ROM;

a random access memory 1112, denoted RAM, able to contain the executable code of the method of the invention as well as the registers adapted to record variables and parameters necessary for implementing the method of encoding a video signal; and

a communication interface 1102 connected to a communication network 1103 over which digital data to be processed are transmitted.

Optionally, the apparatus 1000 may also have the following components:

a data storage means 1104 such as a hard disk, able to contain the programs implementing the invention and data used or produced during the implementation of the invention;

a disk drive 1105 for a disk 1106, the disk drive being adapted to read data from the disk 1106 or to write data onto said disk;

a screen 1109 for displaying data and/or serving as a graphical interface with the user, by means of a keyboard 1110 or any other pointing means.

The apparatus 1000 can be connected to various peripherals, such as for example a digital camera 1100 or a microphone 1108, each being connected to an input/output card (not shown) so as to supply multimedia data to the apparatus 1000.

The communication bus affords communication and interoperability between the various elements included in the apparatus 1000 or connected to it. The representation of the bus is not limiting and in particular the central processing unit is able to communicate instructions to any element of the apparatus 1000 directly or by means of another element of the apparatus 1000.

The disk 1106 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables the method of encoding a digital video signal and/or the method of decoding a compressed bitstream according to the invention to be implemented.

The executable code may be stored either in read only memory 1107, on the hard disk 1104 or on a removable digital medium such as for example a disk 1106 as described previously. According to a variant, the executable code of the programs can be received by means of the communication network, via the interface 1102, in order to be stored in one of the storage means of the apparatus 1000 before being executed, such as the hard disk 1104.

The central processing unit 1111 is adapted to control and direct the execution of the instructions or portions of software code of the program or programs according to the invention, instructions that are stored in one of the aforementioned storage means. On powering up, the program or programs that are stored in a non-volatile memory, for example on the hard disk 1104 or in the read only memory 1107, are transferred into the random access memory 1112, which then contains the executable code of the program or programs, as well as registers for storing the variables and parameters necessary for implementing the invention.

In this embodiment, the apparatus is a programmable apparatus which uses software to implement the invention. However, alternatively, the present invention may be implemented in hardware (for example, in the form of an Application Specific Integrated Circuit or ASIC).

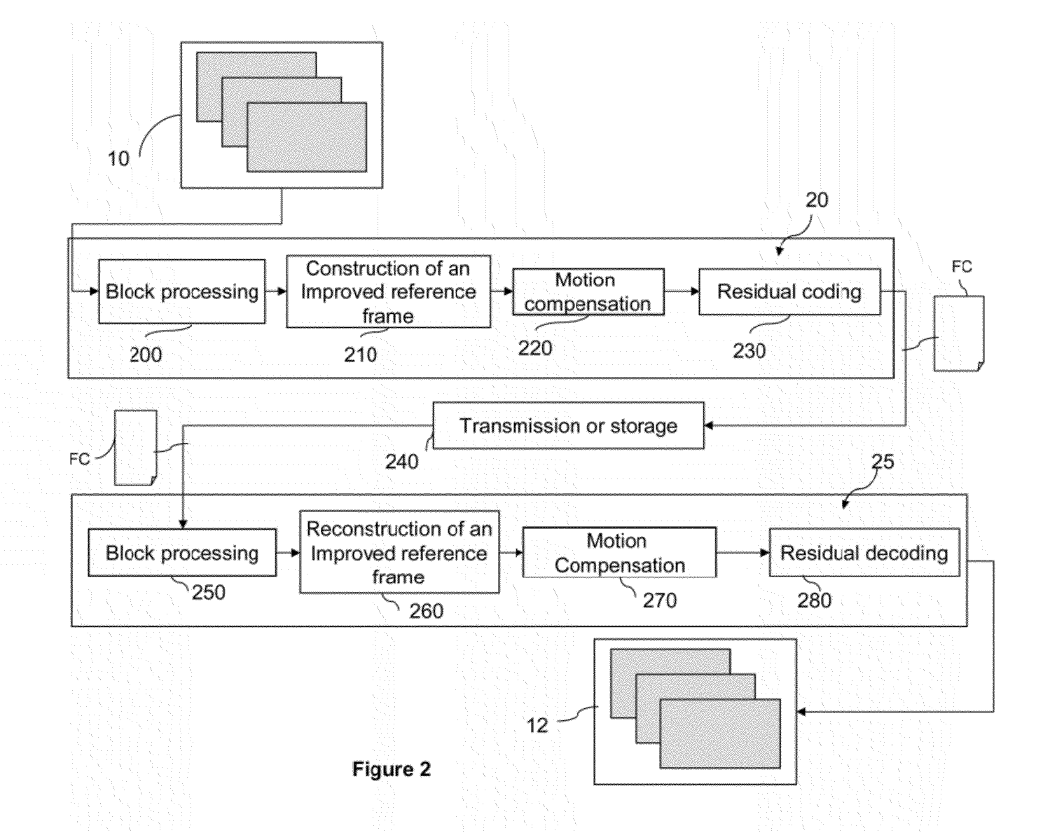

FIG. 2 illustrates a system for processing digital video signals, comprising an encoding device 20, a transmission or storage unit 240 and a decoding device 25.

The embodiment described in particular is dedicated to encoding of sequences of digital images according to a format using motion estimation and motion compensation. As already explained, in such a video encoder, an image or frame of the sequence of images to be encoded is divided into blocks, and some blocks are encoded by difference to reference blocks of one or several reference frames, which reference frames are decoded frames of the video, already processed by the encoder.

Both the encoding device 20 and the decoding device 25 are processing devices 1000 as described with respect to FIG. 1.

An original video signal 10 is provided to the encoding device 20 which comprises several modules: block processing 200, construction of an improved reference frame 210, motion compensation 220 and residual encoding 230. Only the modules of the encoding device which are relevant for an embodiment of the invention are represented.

The original video signal 10 is processed in units of blocks, as described above with respect to various MPEG-type video compression formats such as H.264 and MPEG-4 for example.

So firstly, each video frame is divided into blocks by module 200.

Module 210 is adapted to build an improved reference frame from a reference frame classically selected, as explained in further detail hereafter.

This module 210 is added with respect to a classical video encoder, for example an H.264 video encoder. An improved reference frame can be build from any selected reference frame, but for the sake of simplicity of explanation, we consider than only one reference frame is used. For example, the selected reference frame may be the video frame which is temporally immediately before the current frame to encode.

According to an embodiment, an improved reference frame is build by computing a sample by sample difference frame containing the difference between the current frame to encode and the reference frame, and by selecting a subset of data representative of this difference frame and encoding it along with the current frame. The encoding of the difference frame uses similar encoding parameters as for the encoding of the current frame.

The decoded difference frame is added to the reference frame to provide an improved reference frame. Advantageously, the improved reference frame is closer to the current frame to encode.

In a particular embodiment the subset of data representative of the difference frame to encode is selected so that it contains difference information but does not carry motion information.

The improved reference frame is used for motion compensation in module 220. Motion compensation may be implemented as proposed in H.264, except that an improved reference frame is used instead of a classical reference frame. Typically, a motion estimation is applied to determine, for a current block of the current frame, a reference block from the improved reference frame, which is the best predictor of the current block according to a given cost criterion, such as for example a rate-distortion criterion. A block residual is then computed as the difference between the current block and the selected reference block.

The residual block is encoded by module 230.

Finally, a compressed bitstream FC is obtained, containing the encoded residuals and other data relative to the encoded video and useful for decoding. In particular, the encoded subset of data representative of difference frame obtained by module 210 is transmitted to the decoder, along with other items of information if useful for the generation of the improved reference frame.

The compressed bitstream FC comprising the compressed video signal may be stored in a storage device or transmitted to a decoder device by module 240.

In a particular embodiment, the compressed bitstream is stored in a file, and the decoding device 25 is implemented in the same processing device 1000 as the encoding device 20.

In another embodiment, the encoding device 20 is implemented in a server device, the compressed bitstream FC is transmitted to a client device via a communication network 1103, for example the Internet network or a wireless network, and the decoding device 25 is implemented in a client device.

It is supposed that the transmission and/or storage is lossless, so that no errors occur, and the compressed bitstream can be subsequently completely decoded.

The decoding device 25 comprises a block processing module 250, which retrieves the block division from the compressed bitstream and selects the blocks to process.

Next, module 260 constructs the improved reference frame, using the classical reference frame to which it adds the decoded frame difference obtained from the encoded frame difference received from the encoder.

Module 270 applies motion compensation in a classical manner, except that the improved reference frame obtained by module 260 is used instead of the classical reference frame. For a current block of the current frame to decode, the motion information retrieved from the bitstream is decoded, and a corresponding reference block from the improved reference frame is retrieved.

The residual block corresponding to the current block is decoded by the residual decoding module 280 and added to the improved reference block obtained from module 270.

Finally, a decoded video signal 12 which can be displayed or further processed is obtained.

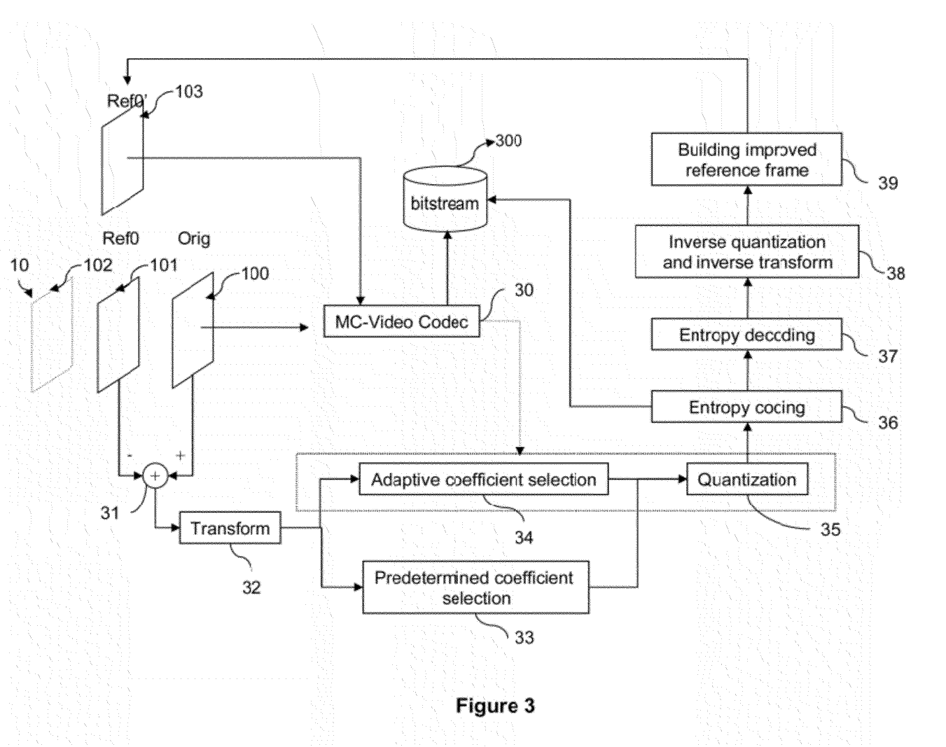

FIG. 3 is a block diagram illustrating a structure of a video encoder according to an embodiment of the invention.

A video sequence 10 is presented to a video encoder. The frames of video sequences are represented, a current frame 100 to be encoded by the motion compensation (MC) video codec 30, and frames 101 and 102 of the video sequence, which precede temporally frame 100. Therefore, it is assumed that frames 102 and 101 have been previously encoded and decoded to serve as reference frames.

In the example of FIG. 3, the original image or frame 100 is to be encoded using motion compensation with respect to a previous reference frame Ref0 101.

In a classical H.264 encoder, Ref0 101 would be used directly as a reference frame.

In this embodiment, an improved reference frame Ref0′ 102 is build to be used for the motion compensation encoding of the original frame 100.

Firstly, the pixel by pixel sample values difference between Orig and Ref0 is computed, in the pixel domain, by the adder/subtractor module 31.

Next, a transform is applied to the difference frame obtained by transform module 32, to generate a transformed difference frame.

Different types of transform may be applied, either a block-based DCT (Discrete Cosine Transform) transform, or a subband transform, also known as wavelet transform.

Next a set of transform coefficients are selected as a subset of data representative of the difference frame.

The selection may be performed either adaptively by module 34 or may be fixed, in which case a predetermined set of coefficients is selected by module 33.

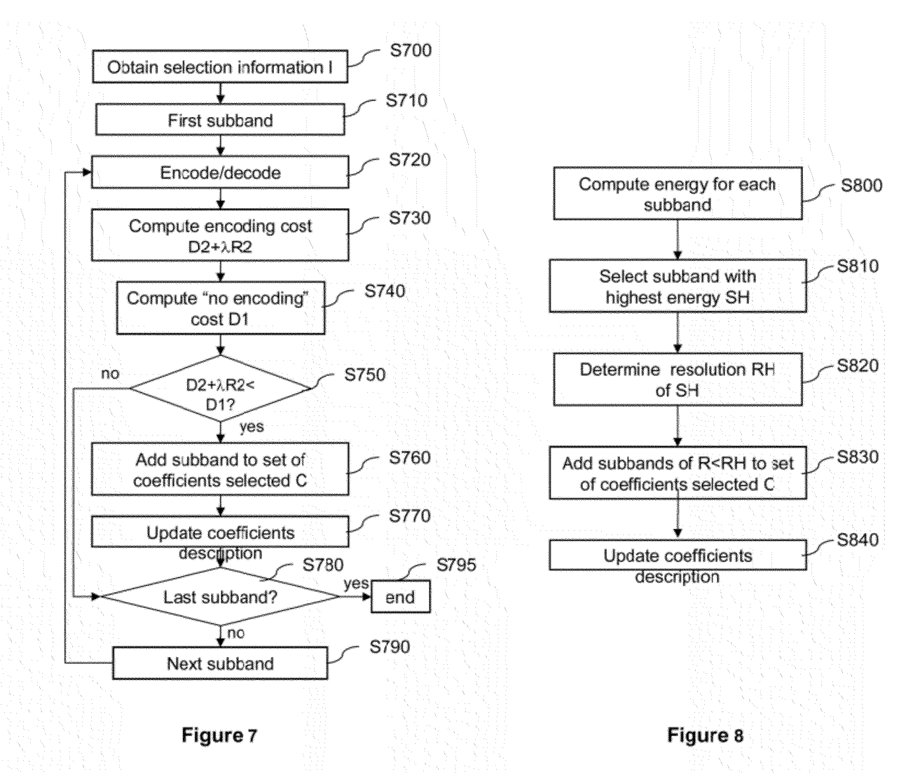

Several embodiments of module 34 can be envisaged, as explained in further detail with respect to FIGS. 7 and 8.

In an embodiment, a set of coefficients is adaptively selected. First, the transform coefficients are split into coefficients that carry motion information and coefficients that carry other difference information. Subsequently, a set of coefficients is selected among the coefficients that do not carry motion information. This is advantageous since the differences due to motion, as for example the translational displacement of an object in the scene, are efficiently handled by the motion compensation, whereas illumination differences are less efficiently handled by motion compensation.

In an alternative embodiment, the set of coefficients is determined adaptively based on a parameter of the video codec 30, such as for example a rate-distortion cost. Advantageously, the rate-distortion of the encoded difference frame can be optimized in such an embodiment.

The selected coefficients are quantized by module 35, and the quantization step may also be adaptively selected based on a coding cost, such as a rate-distortion cost, or simply a cost based on either rate or distortion. The rate represents typically the number of bits necessary to represent the encoded difference frame.

The selected and quantized coefficients are then entropy encoded by module 36 to form an encoded difference frame, which is typically added to the bitstream 300. More generally, the encoded difference frame is transmitted to the decoder. Advantageously, the quantity of encoded data for representing the encoded difference frame is finely tuned with respect to the motion compensated video encoder parameters for the video to be encoded.

Further, additional items of information, such as information describing the selected coefficients in the case the coefficients to represent the difference frame are adaptively selected, are also encoded and stored along with the encoded difference frame.

The encoded difference frame is entropy decoded by module 37, and then an inverse quantization and an inverse transform are applied by module 38 to obtain a decoded difference frame. The inverse transform is the inverse of the transform applied by module 32.

Finally, an improved reference frame Ref0′ 103 is obtained by adding the decoded difference frame to the initial reference frame Ref0, in the pixel domain.

The improved reference frame obtained is used by the classical motion-compensated video codec 30 rather than the reference Ref0 for the motion compensation.

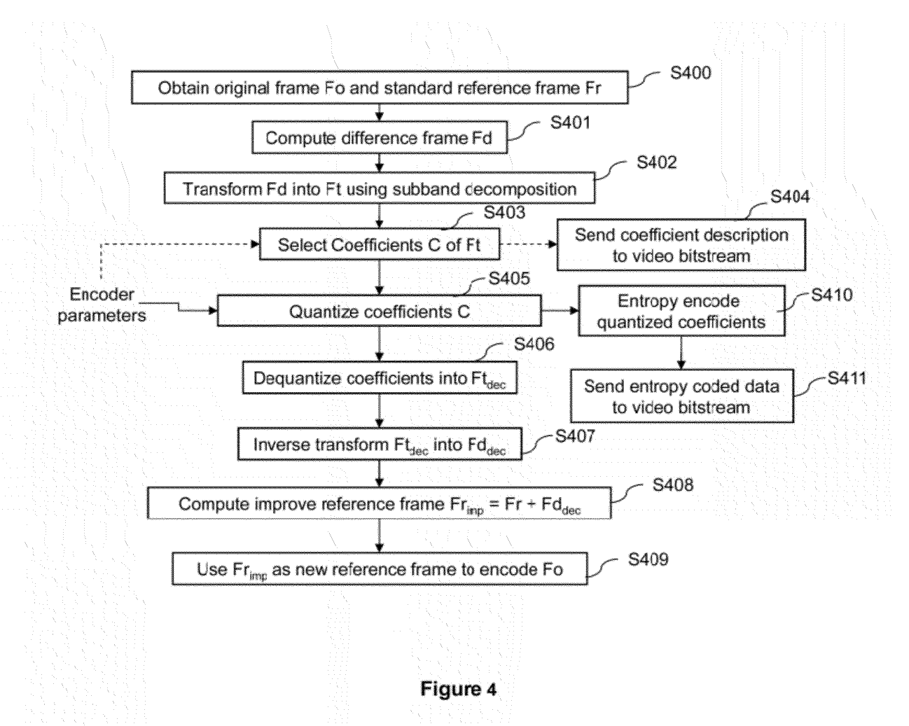

The flow diagram in FIG. 4 illustrates the main steps of an encoding method of a digital video signal according to an embodiment of the invention.

All the steps of the algorithm represented in FIG. 4 can be implemented in software and executed by the central processing unit 1111 of the device 1000.

The algorithm of FIG. 4 illustrates in particular the obtention of an improved reference frame, as implemented by module 210 of FIG. 2.

Firstly, an original frame to encode Fo and a classical reference frame Fr are obtained at step S400. The reference frame Fr is for example the decoded previous frame of the video sequence.

Next, at step S401, a difference frame Fd is computed as the pixel by pixel difference in the spatial domain: Fd(x,y)=Fo(x,y)−Fr(x,y) for every pixel of coordinates (x,y) of the spatial domain.

At following step S402, the difference frame Fd is transformed using a subband decomposition into a transformed frame Ft.

The subband decomposition (also called wavelet transform) is a very well known process (for instance, it is used in the JPEG2000 standard), consisting in filtering and subsampling the frame using high-pass and low-pass filters. Filtering and subsampling along one dimension of the frame produces two frames (one low frequency frame and one high frequency frame), and then on each of the two frames is again applied a filtering and subsampling along the other dimension to produce four subbands:

A subband called LL1, containing the low frequency component of the signal in the horizontal dimension and the low frequency signal along the vertical dimension;

A subband called LH1, containing the low frequency component of the signal in the horizontal dimension and the high frequency signal along the vertical dimension;

A subband called HL1, containing the high frequency component of the signal in the horizontal dimension and the low frequency signal along the vertical dimension;

A subband called HH1, containing the high frequency component of the signal in the horizontal dimension and the high frequency signal along the vertical dimension.

Typically, the LL1 subband is further decomposed into LL2, LH2, HL2, and HH2, following the same processing.

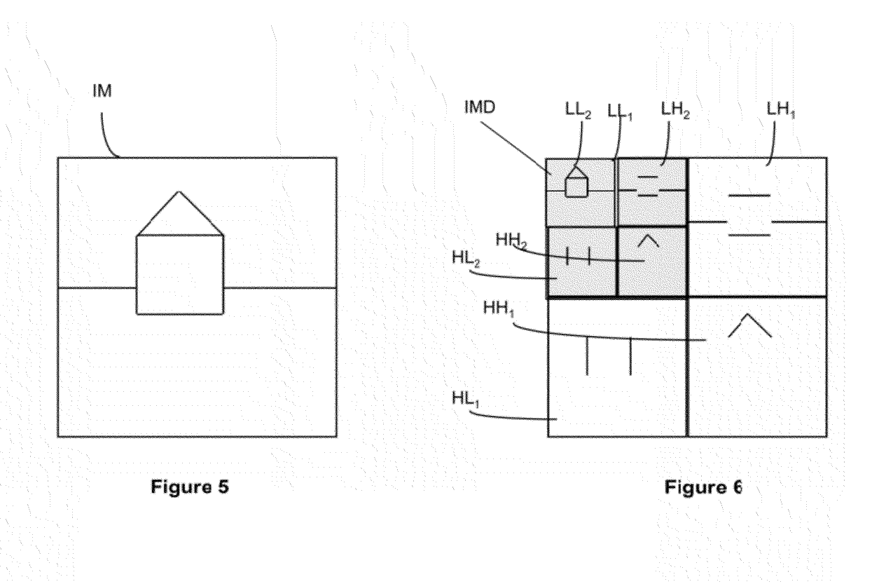

A schematic example is represented with respect to FIGS. 5 and 6. FIG. 5 represents an original image or frame IM, and FIG. 6 represents IMD, the result of the decomposition of IM into subbands LL1 (gray), further decomposed into LL2, LH2, HL2 and HH2, and the subbands LH1, HL1 and HH1.

LL2 can be further decomposed into LL3, LH3, HL3, and HH3, and so on. In the preferred embodiment we will assume that LL3 is not further decomposed, so Ft contains the following subbands: LL3, LH3, HL3, HH3, LH2, HL2, HH2, LH2 HL1, and HH1.

Alternatively, it is possible to further decompose any of the subbands.

Is it common to consider LL1, LH1, HL1 and HH1 to correspond to the highest resolution level, LL2, LH2, HL2 and HH2 correspond to a resolution level immediately lower to the highest resolution, LL3, HL3, LH3 and HH3 correspond to the next lower resolution level, and so on.

In an alternative embodiment, the difference frame Fd is divided into blocks, for example of size 8×8 pixels, and a block-based DCT is applied, to obtain blocks of transform coefficients. Each block of transform coefficients comprises 64 coefficients, in the example of blocks of 8×8 pixels. The transform coefficients can be ordered according to the zigzag scan order known from JPEG standard, and can be noted dc0, ac1, ac2, . . . ac63. By grouping together all coefficients of a given rank, 64 subbands of increasing frequency are obtained.

Thus, in both transform embodiments described above, the transformed frame Ft contains a plurality of subbands of coefficients.

Next, in step S403, a set of coefficients C is selected from the plurality of the transform coefficients arranged by subbands.

Several embodiments of the selection of the set of coefficients C are envisaged.

In a first simple embodiment, a predetermined set of coefficients is selected, for example a predefined set of subbands. For example, it is advantageous to select the lowest resolution subbands (e.g. subbands LL3, LH3, HL3, HH3 in the example of embodiment using the wavelet transform or the 15 first subbands in the DCT transform implementation) since in this case, the number of coefficients representative of the difference is quite low compared to the total number of coefficients. Moreover, the low frequency coefficients are more representative of illumination changes and large scale details of an image signal, as explained in further detail hereafter.

In the case of the selection of a predetermined set of coefficients, it is assumed that this information is shared by the decoder, so it is not necessary to send additional information describing the set of selected coefficients C in the bitstream.

Alternatively, the selection of a set of transform coefficients is carried out adaptively based on the characteristics of the video signal. In this case, since the coefficients selected may vary from frame to frame, an additional item of information representative of the subset of data selected to represent the difference frame, i.e. of the selected coefficients, is also inserted in the bitstream in step S404.

Two main embodiments are described hereafter with respect to the adaptive selection of the set of coefficients.

A first embodiment is the adaptive selection of a set of coefficients C based upon a cost criterion, such as an encoding cost, using selection information obtained from the encoder.

FIG. 7 describes in more detail a first embodiment of an adaptive selection algorithm.

All the steps of the algorithm represented in FIG. 7 can be implemented in software and executed by the central processing unit 1111 of the device 1000.

Selection information I is obtained from the video encoder in step S700. In the preferred embodiment, the selection information is for example the parameter λ which characterizes the rate-distortion compromise and which is used for the computation of the rate-distortion optimization by the video encoder 30 to encode video data, according for example to H.264 format.

Next, the first subband is considered as current subband S in step S710, for example the subband LL3 in the case of the wavelet transform is applied or the subband DC₀ in the case of the DCT transform is applied.

In step S720 the encoding and decoding of the subband is simulated, using parameters from the video encoder. In practice, the transform coefficients of the current subband being processed are quantized using a predetermined quantization, for example a fixed quantization step selected based upon the resolution level of the subband, and then dequantized to obtain the decoded version of the transform coefficients of the subband.

It is then possible to compute the distortion between the decoded coefficients and the original coefficients of the subband, D2. Typically, the distortion D2 may be measured by a sum of absolute differences (SAD), a sum of squared differences or a mean of absolute differences (MAD).

An evaluation of the rate R2, in terms of number of bits necessary to represent the encoded coefficients of subband S is also obtained. For example, R2 is equal to the number of coefficients necessary for the entropy coding of the quantized transform coefficients of the subband. Finally, the encoding cost D2+λR2 is obtained in step S730.

Next, the ‘no encoding’ cost, corresponding simply to the distortion D1 between the current subband and a subband of zeroes is computed (S740). Indeed, this corresponds to the ‘default’ case in which all the coefficients of the subband are approximated to zero and no information relative to those coefficients is transmitted to the decoder.

A comparison between the encoding cost computed and the ‘no encoding’ cost is carried out at step S750. The ‘no encoding’ cost is typically a subband-adaptive threshold, that is dependent, for each subband, on the coefficients of the subband.

If D2+λR2 is lower than D1 (answer ‘yes’ to test S750), then the current subband is added to the set of selected coefficients C (step S760) and then the selected coefficients description is updated to indicate that current subband S is encoded in step S770. For example, if the subbands are indexed in a predetermined order, it is sufficient to encode the index designating the current subband.

If D2+λR2 is not lower than D1 (answer ‘no’ to test S750) step S750 is followed by step S780.

If the current subband S is the last subband (test S780), the adaptive coefficient selection ends (S795).

Otherwise (answer ‘no’ to test S780), the next subband is considered as current subband S (S790), and the steps S720 to S780 are repeated.

In an alternative embodiment to the embodiment of FIG. 7, the selection information I is a bit budget B, corresponding to the maximum number of bits to be spent to encode the difference frame Fd.

In this alternative embodiment, the subbands are considered also in a predetermined order, and for each subband S, an encoding cost is computed as equal to the bitrate R2 to spend to encode the transform coefficients of the subband S. This rate R2 is added to the number of bits already spent b, which is initially equal to 0. The test of S750 is replaced by a test b+R2≦B?, to check whether the quantity of bits already spent b plus the number of bits to encode the current subband R2 exceeds the bit budget B. If the answer is negative, the current subband is selected to be part of the selected coefficients C, and the next subband is considered.

Given that the subbands are processed in a predetermined order, it is only necessary to encode the index to the last subband added to the set of selected coefficients C in the description of the selected coefficients.

FIG. 8 describes in more detail a second embodiment of an adaptive selection algorithm.

All the steps of the algorithm represented in FIG. 8 can be implemented in software and executed by the central processing unit 1111 of the device 1000.

In this embodiment, the coefficients are selected so as to preferably include coefficients that carry information other than motion information, i.e. mainly information relating to the illumination changes. Indeed, the difference frame Fd contains two types of significant signals.

One type is motion-related signals, due to the motion of objects between the current frame and the reference frame. Typically, motion-related signals are high-energy signals of small spatial scale along the edges.

Another type of signals is illumination-related signals, where the difference frame is representative of changes in illumination. Such changes in illumination may be global changes, for example due to a fade in or fade out of the video, or a change in sun radiance over the scene of the video, or local changes, for example a shadow cast over a specific area of the video scene. Typically, the signals of the second type have low energy of large spatial scale distributed over homogeneous regions.

In this second embodiment of the adaptive selection of a set of transform coefficients, it is intended to select mainly coefficients representative of the second type of signals, provided that the first type of difference is efficiently dealt with by the motion compensation. It is therefore an aim of this embodiment to select coefficients belonging to the second type of signal representative of illumination differences.

In the embodiment of FIG. 8, firstly, in step S800, an energy value is computed for each subband S of coefficients. The energy can be computed by the sum or the average of the squares of the values of all coefficients of the subband S, which may be normalized using a normalization factor according to the dynamic range of the filter used to perform the decomposition into subbands. For example, if the dynamic range is multiplied by 2 for each resolution level (i.e. coefficients of subbands of resolution level 1, LH1, HL1, HH1 have a range [−a,a]; coefficients of subbands of resolution level 2, LH2, HL2, HH2 have a range [−2a, 2a]etc), then the coefficients of a subband S of level I should be divided by 2^{I} to have similar ranges throughout all resolution levels.

The subband SH with highest computed energy value is selected at step S810, and the resolution level RH of SH is determined at step S820. This subband of coefficients SH represents a first set of transform coefficients containing motion details and therefore representative of motion information of the difference frame being processed.

Then at step S830, all subbands of coefficients of resolution level R lower than RH are selected to form the set of selected coefficients C. It is expected that such coefficients belong to the second type of signal since they contain lower energy than the subband SH and have lower resolutions which correspond to larger spatial structures. The selected coefficients belong to other subbands than SH. In more general terms, the selected coefficients do not belong to the first set of coefficients, representative of motion information.

The selected coefficients to form the set of coefficients C are indicated by updating the coefficients description at step S840, typically by indicating the highest resolution level of the selected subbands, since in this embodiments all subbands of coefficients of resolution levels lower than a given resolution level RH are selected.

Alternatively, other criteria to determine the subbands of coefficients belonging to the first and/or second type of signals may be used. For example, it is possible to use an edge detector, such as the well known Sobel edge detector, to analyse the subbands and detect the subband SH that has the largest quantity of edge information.

Back to FIG. 4, after the step S403 of selection of a set of transform coefficients C, the selected coefficients are quantized in step S405.

In the preferred embodiment, scalar quantization is used, where a quantization step qS is selected for each subband of coefficients S.

However, alternative quantization means, such as vector quantization, can be equally used.

When using scalar quantization, the quantization steps can be chosen to minimize a cost criterion, typically the rate-distortion compromise for each subband based on the encoder parameter λ. For a given subband S, a plurality of quantization steps q are tested by simulating encoding and decoding with q, and by computing the a rate-distortion compromise C(q)=Ds(q)+λRs(q), where Ds(q) is the distortion between the original coefficients of subband S and their decoded value obtained by quantization/inverse quantization with quantization step q, and Rs(q) is the rate that would be spent for encoding the quantized subband S. The value of Rs(q) can be obtained by simulating an entropy coding of the quantized subband coefficients.

The value of q that minimizes C(q) is selected as the quantization step qS for subband S.

More generally, other rate and or distortion criteria may be used to select the encoding parameters, such as the quantization steps. For example, an overall rate or bit target to be reached may be used a cost criterion to determine the quantization step for a subband of coefficients.

It should be noted that if the embodiment of FIG. 7 has been applied to select the set of coefficients C, then the same quantization steps as used for the adaptive selection of the coefficients should be used.

After applying the quantization of step S405, the quantized transform coefficients representative of the difference frame are entropy encoded in step S410 to obtain the encoded difference frame, and then send to the bitstream in step S411. Indeed, the encoded difference frame will be subsequently sent to the decoder along with the encoded video data, so that an improved reference frame for the motion compensation can also be computed at the decoder. Steps S410 and S411 can be applied any time after S405.

The encoded difference frame can be integrated in the bitstream comprising the encoded video data, or can be sent separately, for example in metadata containers, along with the encoded video data.

After the quantized coefficients representative of the difference frame are computed (step S405), they are subsequently inverse quantized or de-quantized in step S406, so as to obtain a decoded coefficients frame Ft_{dec}. Note that all coefficients of the frame Ft_{dec} that have not been selected are simply set to 0.

Next, in step S407, an inverse transform is applied to the coefficients of Ft_{dec}, to obtain a decoded difference frame Fd_{dec}. The inverse transform of step S407 is simply the inverse of the transform, applied in step S402, either wavelet transform or block-based DCT. Note also that in the embodiment using the block-based DCT, before applying the inverse transform the dequantized coefficients of the subbands have to be re-distributed to their locations in the blocks, so as to form localized blocks of coefficients from all subbands.

The improved reference frame Frᵢₘₚ is computed in step S408 by adding the decoded difference frame to the original reference frame Fr in the pixel domain: Frᵢₘₚ(x,y)=Fr(x,y)+Fd_{dec}(x,y) for every pixel of coordinates (x,y) in the spatial domain.

Finally, the improved reference frame Frᵢₘₚ is used to encode the current original frame Fo according to any known motion estimation and compensation algorithm (S409).

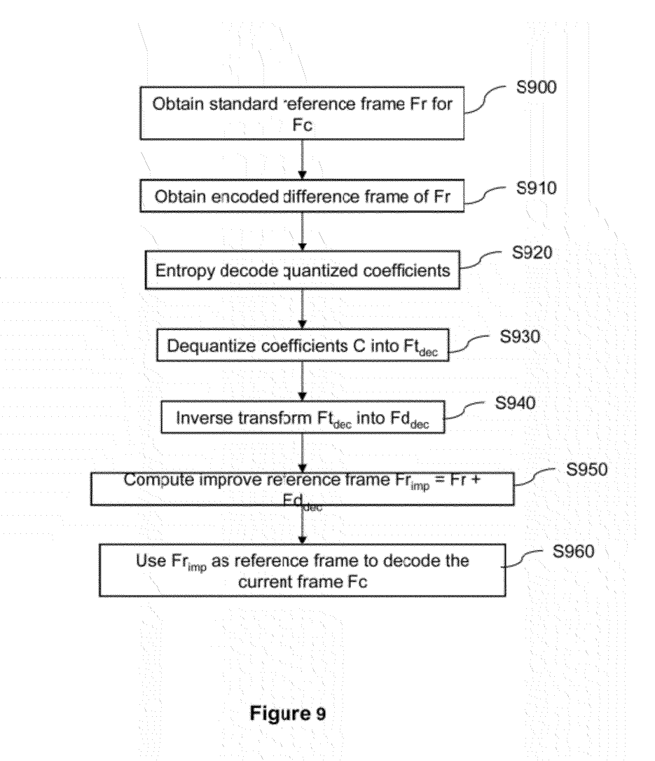

The flow diagram in FIG. 9 illustrates the main steps of a method for decoding a video bitstream using an improved reference frame according to an embodiment of the invention.

All the steps of the algorithm represented in FIG. 9 can be implemented in software and executed by the central processing unit 1111 of the device 1000.

The decoder receives, along with the bitstream of compressed video data, encoded data representative of an encoded difference frame generated using one of the algorithms described above, in particular with respect to FIG. 4.

The method of FIG. 9 is described with respect to a current frame Fc to decode.

Firstly, in step S900, a so-called standard reference frame Fr is obtained. Classically, Fr is indicated in the bitstream as the frame used for motion compensation in the encoder.

Next, at step S910, the data representative of the encoded difference frame for frame Fr with respect to frame Fc is obtained. Depending on the embodiment, supplementary information indicating the selected coefficients C is also retrieved along with the data representative of the encoded difference frame.

In step S920 an entropy decoding is applied to the data representative of the encoded difference frame to obtain the quantized transform coefficients selected.

The quantized transform coefficients are next inverse quantized or de-quantized in step S930. If necessary, the values of the quantization steps used per subband are indicated in the encoded data representative of the encoded difference frame, so the step of inverse quantization can be applied straightforwardly.

The information on the selected set of coefficients, if present, i.e. in case the set of selected coefficients is not pre-determined, is used to associate the received coefficients with the subbands they belong to. The coefficients of the subbands that do not belong to the set of selected coefficients C are set to 0, so as to build a frame of dequantized coefficients Ft_{dec}.

Next an inverse transform is applied to Ft_{dec} in step S940, to obtain a decoded difference frame Fd_{dec}.

Similarly to step S407 of FIG. 4, the inverse transform of the transform used for the encoding is applied, so the decoder either knows in advance or retrieves an information relative to the transform applied from the encoded data. Similarly to step S407, in the embodiment using the block-based DCT, before applying the inverse transform, the dequantized coefficients of the subbands have to be re-distributed to their locations in the blocks, so as to form localized blocks of coefficients from all subbands.

The improved reference frame Frᵢₘₚ is then built in step S950 by adding the decoded difference frame Fd_{dec} to the reference frame Fr: Frᵢₘₚ=Fr+Fd_{dec} on a pixel by pixel basis.

The improved reference frame is then used to proceed to the decoding with motion compensation (S960) with no other change to a classical decoder than using Frᵢₘₚ instead of Fr as a reference frame.

The embodiments above have been described with the grouping of transform coefficients representative of the difference frame into subbands, each subband having some specific frequency characteristics. However, other methods for grouping coefficients may be applied, so as to select some groups of the plurality of groups of coefficients in the set of selected coefficients C. For example, the coefficients may be considered by blocks or tiles, and some tile may be chosen to represent the difference frame.

Also, without any preliminary grouping of the coefficients representative of the difference frame, it may be envisaged to select a subset of representative coefficients of the difference frame, based on some predetermined such as for example their magnitude compared to a predetermined threshold.

1. Method for encoding a digital video signal composed of video frames into a bitstream, each video frame being divided into blocks, wherein at least one block of a current frame is encoded by motion compensation using a block of a reference frame,
comprising the steps of:
computing a difference frame between a current frame and a reference frame of said current frame,
selecting a subset of data representative of the difference frame computed,
encoding said subset of data to obtain an encoded difference frame,
decoding said encoded difference frame and adding the decoded difference frame to said reference frame to obtain an improved reference frame and
using said improved reference frame for motion compensation encoding of said current frame.

2. A method according to claim 1, further comprising a step of including said encoded difference frame in the bitstream.

3. A method according to claim 1, wherein an item of information indicating the subset of data selected is encoded in the bitstream.

4. A method according to claim 1, wherein the step of selecting a subset of data further comprises:
applying a transform to the difference frame computed to generate a plurality of transform coefficients, and
selecting a set of transform coefficients to form a subset of data representative of the difference frame.

5. A method according to claim 4, wherein the step of selecting a set of transform coefficients comprises:
determining, among the plurality of transform coefficients, a first set of transform coefficients representative of motion information of said difference frame, and
selecting a set of transform coefficients from transform coefficients that do not belong to said first set of transform coefficients.

6. A method according to claim 5, wherein the plurality of transform coefficients are organized in a plurality of subbands of coefficients, a said first set of transform coefficients being selected as the subband of coefficients having the highest energy content.

7. A method according to claim 6, wherein each subband of coefficients has an associated resolution level, and wherein the set of transform coefficients selected comprises coefficients belonging to subbands of coefficients of resolution level lower than the resolution level of the subband of coefficients forming the first set of transform coefficients.

8. A method according to claim 4, wherein the step of selecting a set of transform coefficients comprises selecting adaptively a set of transform coefficients based upon a cost criterion.

9. A method according to claim 8, wherein the plurality of transform coefficients is organized in a plurality of subbands of coefficients, wherein the step of selecting adaptively a set of transform coefficients comprises, for each subband of coefficients taken in a predetermined order,
applying encoding and decoding of said subband of coefficients,
estimating an encoding cost of said subband of coefficients, and
selecting said subband of coefficients if said encoding cost is lower than a threshold.

10. A method according to claim 9, wherein said encoding cost is a rate-distortion cost computed using a parameter used to encode video data of said digital video.

11. A method according to claim 9, wherein said threshold is dependent, for each subband of coefficients, on the coefficients of said subband of coefficients.

12. A method according to claim 4, wherein the plurality of transform coefficients is organized in a plurality of subbands of coefficients, and wherein a predetermined set of subbands of transform coefficients is selected.

13. A method according to claim 4, further comprising a step of encoding said set of transform coefficients selected to obtain said encoded difference frame.

14. A method according to claim 13, wherein the step of encoding said set of transform coefficients selected comprises quantizing the coefficients of said set of transform coefficients selected.

15. A method according to claim 13, wherein the encoding of said set of transform coefficients selected comprises selecting at least one encoding parameter so as to satisfy a rate and/or distortion criterion.

16. Method for decoding a bitstream comprising encoded frames representative of a digital video signal, each video frame being divided into blocks, wherein at least one block of a current frame is encoded by motion compensation using a block of a reference frame, comprising the following steps:
obtaining a reference frame for a current frame to decode,
obtaining an encoded difference frame representative of the difference between said reference frame and said current frame to decode,
decoding said encoded difference frame to obtain a decoded difference frame,
adding the decoded difference frame to said reference frame to obtain an improved reference frame and
using said improved reference frame for motion compensation decoding of said current frame to decode.

17. Device for encoding a digital video signal composed of video frames into a bitstream, each video frame being divided into blocks, wherein at least one block of a current frame is encoded by motion compensation using a block of a reference frame, comprising:
a processing unit for computing a difference frame between a current frame and a reference frame of said current frame,
a processing unit for selecting a subset of data representative of the difference frame computed,
a processing unit for encoding said subset of data to obtain an encoded difference frame,
a processing unit for decoding said encoded difference frame and adding the decoded difference frame to said reference frame to obtain an improved reference frame and
a processing unit for using said improved reference frame for motion compensation encoding of said current frame.

18. Device for decoding a bitstream comprising encoded frames representative of a digital video signal, each video frame being divided into blocks, wherein at least one block of a current frame is encoded by motion compensation using a block of a reference frame, comprising :
a processing unit for obtaining a reference frame for a current frame to decode,
a processing unit for obtaining an encoded difference frame representative of the difference between said reference frame and said current frame to decode,
a processing unit for decoding said encoded difference frame to obtain a decoded difference frame,
a processing unit for adding the decoded difference frame to said reference frame to obtain an improved reference frame and
a processing unit for using said improved reference frame for motion compensation decoding of said current frame to decode.

19. A computer program which, when run on a computer, causes the computer to carry out a method for encoding a digital video signal according to claim 1 or a method for decoding a bitstream according to claim 16.

20. A computer-readable storage medium storing a program according to claim 19.

21. A bitstream comprising encoded frames representative of a digital video signal, each video frame being divided into blocks, wherein at least one block of a current frame is encoded by motion compensation using a block of a reference frame, said bitstream comprising data representative of an encoded difference frame obtained by :
computing a difference frame between a current frame and a reference frame of said current frame,
selecting a subset of data representative of the difference frame computed,
encoding said subset of data to obtain an encoded difference frame.
